(19) United States
(12) Patent Application Publication
(10) Pub. No.: US 2002/0101411 A1
(43) Pub. Date: Aug. 1, 2002

(54) Protecting device of an electronic panel of a personal digital assistant

(76) Inventor: Andy Chang, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/769,477

(22) Filed: Jan. 26, 2001

(51) Int. Cl. G09G 5/00

(52) U.S. Cl. 345/179

(57) ABSTRACT

A protecting device of an electronic panel of a personal digital assistant comprises a protecting cover. A personal digital assistant has an electronic panel thereon and has a side installed with a dedicated pen. The protecting cover is a hollow cover and a window being formed therein. The window has a transparent plate. The protecting cover is detachable and pivotally connected to one side of the personal digital assistant. The protecting cover serves to cover on the electronic panel of the personal digital assistant. Another side of the protecting cover is installed with a buckling end for being buckled to the dedicated pen of the personal digital assistant. The present invention serves to avoid the electronic panel to be worn or broken and the protecting cover is fixed well so as to have a preferred protecting effect. Furthermore, the protecting cover is detachable for being updated.

### FIELD OF THE INVENTION

The present invention relates to a protecting device of an electronic panel of a personal digital assistant, and especially to a protecting cover suitable to the be used in a personal digital assistant avoiding an electronic panel of the personal digital assistant to be worn or broken and the protecting cover is fixed well so as to have a preferred protecting function. Furthermore, the protecting cover is detachable for updating.

### BACKGROUND OF THE INVENTION

The personal digital assistant is a novel portable device having a volume smaller than a notebook computer. The personal digital assistant can be placed on a palm and operated thereon. The personal digital assistant is more and more popular recently.

The personal digital assistant has many functions and is dedicated for people outdoors. A personal digital assistant can store a large amount of data comprising addresses of friends, a traveling schedule, items to be engaged, a memo, etc. When the directory number of someone is desired to be searched, it can be found quickly and conveniently in the personal digital assistant without needing to search from a memo. Furthermore, the name cards of someone can be found in the personal digital assistant quickly.

Other then basic functions, most of the personal digital assistants can be connected to computers. For example, the e-mail not to be read can be transferred to a personal digital assistant for being read and give a response in traffic time. Some personal digital assistants are installed with various applications, such as a simple accounting trial balance, an electronic map, a text processing, an e-book, even games.

Besides, some personal digital assistants are built with wireless communication modules. Other than as a pager, the rear-time information, such as finical and stock messages, traffic conditions, climate prediction, news, etc. In future, it is very possible that a personal digital assistant will be combined with a mobile phone. Therefore, only one machine can do many things.

However, the electronic panels (display) of the prior art personal digital assistants are not installed with any protecting device so that the electronic panel is easy to be worn and broken. Especially, in carrying, the electronic panel is easy to wear and break due to collision.

Although, some personal digital assistants have installed with covers on the electronic panels for protecting the electronic panel. Since the cover does not be fixed well, it easily opens in carrying. Therefore, the effect of protection is finite. The cover is un-detachably connected to the personal digital assistant. After being used for a time period, the cover will wear. Since it can not be updated, a trouble to the user is induced.

### SUMMARY OF THE INVENTION

Accordingly, the primary object of the present invention is to provide a protecting device of an electronic panel of a personal digital assistant, wherein a protecting cover is formed. As the personal digital assistant is not used, the protecting cover covers on the electronic panel for avoiding the electronic panel to wear or break.

Another object of the present invention is to provide a protecting device of an electronic panel of a personal digital assistant, wherein the protecting cover is buckled to a dedicated pen of a personal digital assistant and then is positioned thereon. In carrying, the cover does not open and thus provides a preferred protecting effect.

A further object of the present invention is to provide a protecting device of an electronic panel of a personal digital assistant, wherein the protecting cover is detachably connected to the personal digital assistant. After being used for a time period, as the protecting cover is worn, it can be detached for updating.

To achieve the aforesaid object, the present invention provides a protecting device of an electronic panel of a personal digital assistant comprises a personal digital assistant and a protecting cover. The personal digital assistant has an electronic panel thereon and has a side installed with a dedicated pen. The protecting cover is a hollow cover and a window being formed therein. The window has a transparent plate. The protecting cover is detachable and pivotally connected to one side of the personal digital assistant. The protecting cover serves to cover on the electronic panel of the personal digital assistant. Another side of the protecting cover is installed with a buckling end for being buckled to the dedicated pen of the personal digital assistant.

The various objects and advantages of the present invention will be more readily understood from the following detailed description when read in conjunction with the appended drawing.

### BRIEF DESCRIPTION OF THE DRAWINGS

FIG. 1 is a perspective view showing that the protecting cover and the personal digital assistant of the present invention are not connected with one another.

FIG. 2 is a perspective view showing that the protecting cover and the personal digital assistant of the present invention are connected with one another and the cover covers on the electronic panel.

FIG. 3 is a plane view showing that the protecting cover and the personal digital assistant of the present invention are connected with one another and the cover covers on the electronic panel.

FIG. 3A shows the detail of FIG. 3.

FIG. 4 is a plane view showing that the protecting cover and the personal digital assistant of the present invention are connected with one another and the cover is opened.

### DETAILED DESCRIPTION OF THE PREFERRED EMBODIMENTS

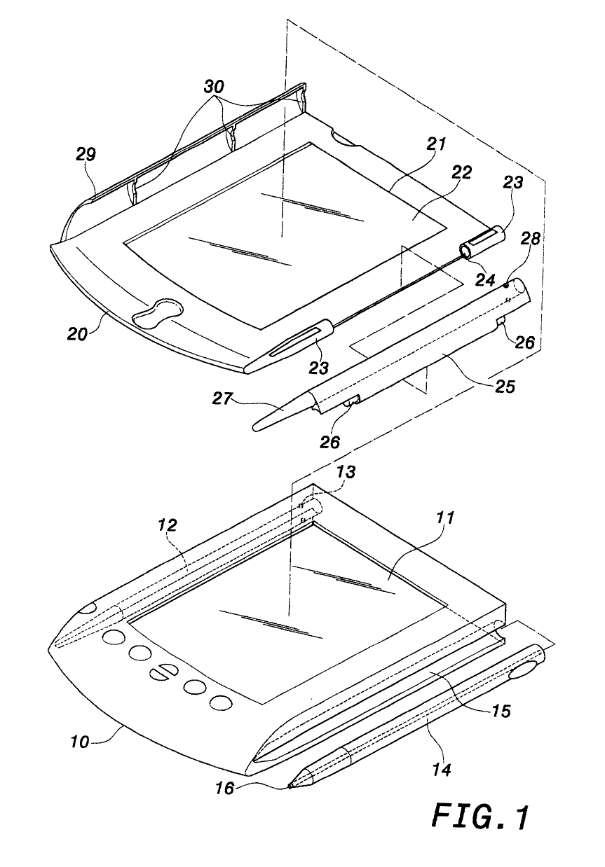

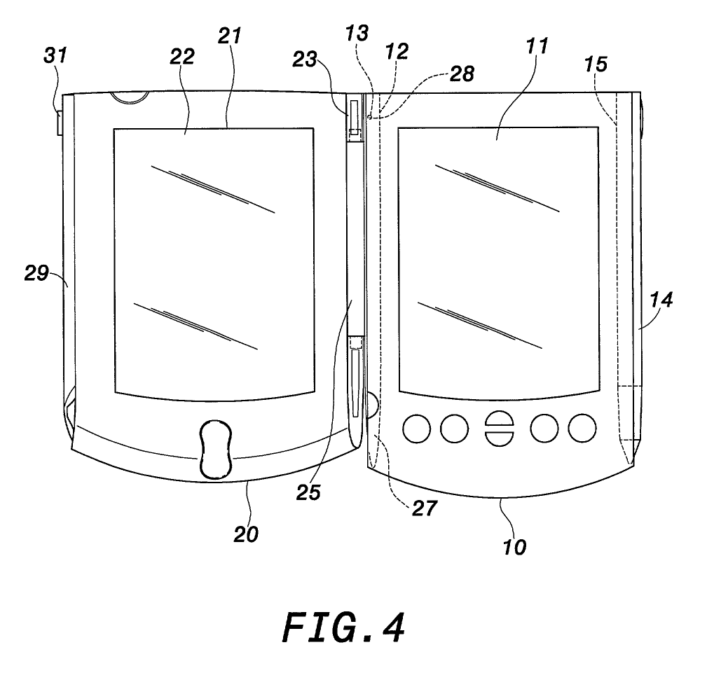

With reference to FIGS. 1 to 4, a preferred embodiment about the protecting device of an electronic panel of a personal digital assistant according to the present invention is illustrated. In the present invention, a protecting cover 20 is connected to a personal digital assistant 10. The outlook of the protecting cover 20 is approximately like a hollow cover with a window 21 therein. The shape of the window 21 is correspondent to the electronic panel 11 of the personal digital assistant 10. The window 21 has a transparent body 22 matched therewith. The transparent body 22 can have various colors. The transparent body 22 is buckled to the window 21 by buckling or other detachable ways. One side of the protecting cover 20 is installed with a movable block 31 for opening the protecting cover 20 by fingers.

One side of the protecting cover 20 is installed with two pivotal seats 23. The inner part of the pivotal seat 23 has an axial hole 24. The two pivotal seats 23 are connected to respective pivotal elements 25. Each pivotal element 25 has a front and a rear end each of which is formed with an pivotal shaft 26. The two pivotal shafts 26 are pivotally connected to the axial holes 34 of the two pivotal seats 23 so that the pivotal element 25 is pivotally connected to one side of the protecting cover 20.

The pivotal element 25 is further formed with a longer connecting shaft 27. The front and rear end of the connecting shaft 27 are protruded out of the pivotal element 25 with an appropriate length. The rear end thereof is buckled with two buckling bodies 28. One side of the personal digital assistant 10 is installed with a connecting hole 12. The rear side and lateral side of the connecting hole 12 are opened. The rear end of the connecting hole 12 is installed with two buckle holes 13 with respect to the buckling bodies 28. The connecting shaft 27 of the pivotal element 25 is inserted from the rear end of the connecting hole 12 so that the connecting shaft 27 of the pivotal element 25 is matched in the connecting hole 12. Two buckling bodies 28 of the pivotal element 25 can be buckled to the two buckle holes 13 of the connecting hole 12. Thereby, the pivotal element 25 can be fixedly to one side of the personal digital assistant 10. Then, the protecting cover 20 can be pivotally connected to one side of the personal digital assistant 10 by the pivotal shaft 26 of the pivotal element 25.

Another side of the protecting cover 20 is installed with a buckling end 29 with a plurality of grooves 30 for being engaged to a dedicated pen (a touch controlled pen) 14 of the personal digital assistant 10. In general, one side of the personal digital assistant 10 is installed with a buckling groove 15 serving for being buckled to a dedicated pen 14. In the present invention, by the installation of a dedicated pen 14, a function of engaging with the groove 15 is provided so that as the protecting cover 20 is covered, the groove 30 at the buckling end 29 to be engaged in the dedicated pen 14. By the aforesaid structure, the protecting cover of an electronic panel of a personal digital assistant is formed.

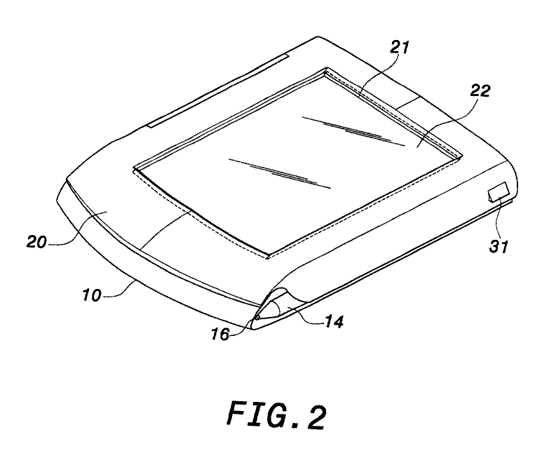

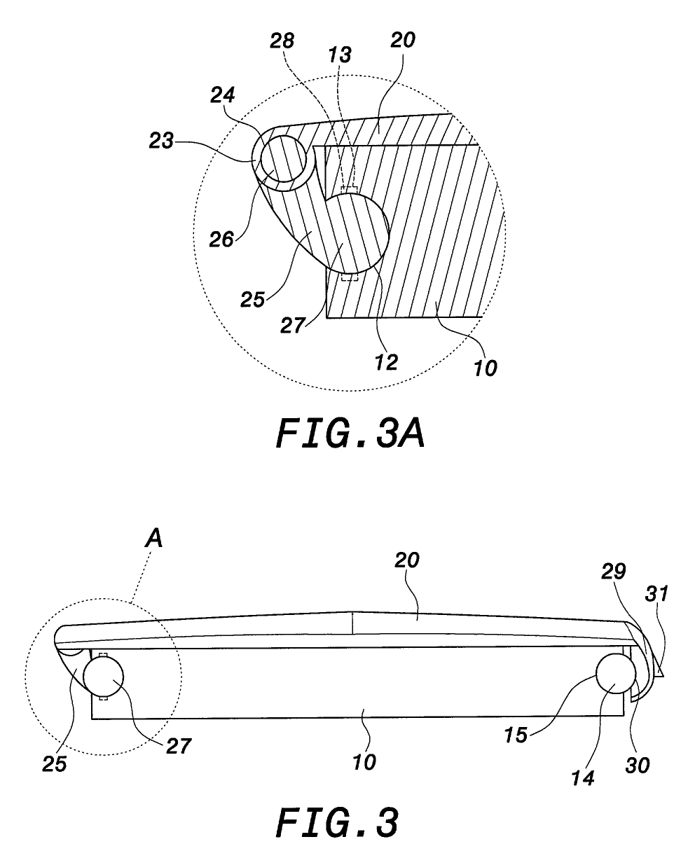

In the present invention, a protecting device is formed by the protecting cover 20. When the personal digital assistant 10 is not used. The protecting cover 20 can be placed on the electronic panel 11 of the personal digital assistant (referring to FIGS. 2 and 3) for avoiding the electronic panel 11 to be worn and broken.

The protecting cover 20 of the present invention can be engaged to the dedicated pen 14 of the personal digital assistant 10 and thus to be positioned therein. Since the protecting cover 20 has been fixed well, in carrying, a preferred protecting protection is provided.

The protecting cover 20 of the present invention is detachable connected to the personal digital assistant 10 by the pivotal element 25. It is only necessary to draw the connecting shaft 7 of the pivotal element 25 out of the connecting hole 12 of the personal digital assistant 10. Then, the protecting cover 20 is separable from the personal digital assistant 10. Therefore, after being used for a time period, as the protecting cover 20 is worn or destroyed, the protecting cover 20 can be detached for updating.

Moreover, a fiber 16 can be installed within the dedicated pen 14 of the present invention. The fiber 16 passes through the front and rear ends of the dedicated pen 14. When the dedicated pen 14 is used, the light is guided from the rear end to the front end so that the front end of the dedicated pen 14 lights up and therefore, the light in the front end of the dedicated pen 14 can point to the electronic panel 11 of the personal digital assistant 10 for indication.

In summary, the present invention serves to avoid the electronic panel to be worn or broken and the protecting cover is fixed well so as to have a preferred protecting effect. Furthermore, the protecting cover is detachable for updating.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A protecting device of an electronic panel of a personal digital assistant, comprising:
a personal digital assistant having an electronic panel thereon and having a side installed with a dedicated pen; and
a protecting cover being a hollow cover and a window being formed therein, the window having a transparent plate; the protecting cover being detachable and pivotally connected to one side of the personal digital assistant; the protecting cover serving to cover on the electronic panel of the personal digital assistant; another side of the protecting cover being installed with a buckling end for being buckled to the dedicated pen of the personal digital assistant.

2. The protecting device of an electronic panel of a personal digital assistant as claimed in claim 1, wherein a fiber is installed in the dedicated pen; and the fiber pass through a front end and a rear end of the; d.

3. The protecting device of an electronic panel of a personal digital assistant as claimed in claim 1, wherein one side of the protecting cover is installed with a movable block.

4. The protecting device of an electronic panel of a personal digital assistant as claimed in claim 1, wherein the buckling end of the protecting cover is formed with a plurality of grooves for being engaged with the dedicated pen of the personal digital assistant.

5. The protecting device of an electronic panel of a personal digital assistant as claimed in claim 1, wherein the transparent plate of the protecting cover is detachably connected to the window.

6. The protecting device of an electronic panel of a personal digital assistant as claimed in claim 1, wherein one side of the protecting cover is installed with pivotal seats, each pivotal seat is installed with an axial hole therein; each pivotal seat is connected to a pivotal element; the pivotal element is installed with a pivotal shaft; the pivotal shaft is pivotally connected to the axial hole of the pivotal seat so that the pivotal element is pivotally connected to one side of the protecting cover; the pivotal element is installed with a connecting shaft; one end of the connecting shaft is installed with a buckling body; one side of the personal digital assistant is installed with a connecting hole; and the buckling body of the pivotal element is buckled to the buckle hole so that the pivotal element is detachable and pivotally connected to one side of the personal digital assistant.
